(19) United States
(12) Patent Application Publication
(10) Pub. No.: US 2016/0096357 A1
(43) Pub. Date: Apr. 7, 2016

(54) SPINDLE DISC ASSEMBLY

(71) Applicant: E I DU PONT DE NEMOURS AND COMPANY, Wilmington, DE (US)

(72) Inventors: ISAO FUKAZU, HAGA-GUN (JP); SHIN-ICHI NAKAGAWA, TOCHIGI (JP); BUNICHI RAI, TOKYO (JP)

(21) Appl. No.: 14/503,501

(22) Filed: Oct. 1, 2014

(51) Int. Cl. B41F 17/20

(52) U.S. Cl. CPC B41F 17/20

(57) ABSTRACT

This disclosure relates to a spindle disc assembly comprising: a spindle disc having a plurality of spindle assemblies disposed along the periphery of the spindle disc, the spindle assemblies each comprising a spindle cover, wherein the spindle cover has a wall thickness in a range from about 1 mm to about 10 mm, and wherein the spindle cover comprises a non-thermoplastic polyimide.

### FIELD OF THE INVENTION

The disclosure relates generally to spindle disc assemblies, and more particularly, spindle disc assemblies having, among other elements, a plurality of non-thermoplastic polyimide spindle covers.

### BACKGROUND OF THE INVENTION

Beverage, and other, can printing systems and assemblies include elements such as spindles, spindle discs, spindle assemblies, spindle disc assemblies, and other elements that move at high speed in relation with beverage cans to be printed on. During the beverage can printing process, the beverage can has a surface that may be exposed to high friction, high temperatures, high velocity, and other conditions that may cause the can surface to wear and undergo other forms of degradation due to contact of the wear surface with the spindles, the spindle discs, the spindle assemblies, the spindle disc assemblies, and other elements of the beverage can printing system.

Elements of beverage can printing systems are also exposed to wear conditions based on high speed operation of the system and mechanical motion, interaction, and engagement of elements in the system.

### SUMMARY OF THE INVENTION

An aspect of the present invention relates to a spindle disc assembly comprising: a spindle disc having a plurality of spindle assemblies disposed along the periphery of the spindle disc, the spindle assemblies each comprising a spindle cover, wherein the spindle cover has a thickness in range of 1 to 10 mm, and wherein the spindle cover comprises a non-thermoplastic polyimide.

The illustrative aspects of the present invention are designed to solve the above-stated problems described and improve other aspects of the beverage printing can system.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 depicts an embodiment of a side view of a spindle disc assembly, in accordance with the present invention;

FIG. 2 depicts an embodiment of a face view of the spindle disc assembly, in accordance with the present invention;

FIG. 3 depicts an embodiment of a spindle assembly, in accordance with the present invention;

FIG. 4 depicts an embodiment of a partial cross-section of the spindle assembly, in accordance with the present invention;

FIG. 5 depicts an embodiment of two steps of a method of making the spindle assembly, in accordance with the present invention;

FIG. 6 depicts an embodiment of a cross-section of the spindle assembly, in accordance with the present invention;

FIG. 7 depicts a method of measurement of wear volume of spindle covers used in Examples 1, 2 and Comparative Example 1;

FIG. 8 depicts a method of measurement of wear volume of spindle covers used in Examples 1, 2 and Comparative Example 1; and

FIG. 9 depicts measured wear volume of the spindle covers used in Examples 1, 2 and Comparative Example 1.

### DETAILED DESCRIPTION OF THE INVENTION

Beverage can printing assemblies and systems include mechanical elements such as spindles, spindle discs, spindle assemblies, spindle disc assemblies, and other elements that move at high speed in relation with beverage cans to be printed on. Typically the cans are mounted on spindles or spindle assemblies which are disposed along the periphery of a large continuously rotating disc-like carrier, a spindle disc. The beverage cans then are exposed to a printing process and are subsequently removed from the spindles or spindle assembly. A typical beverage can printing system can process about 1,000 beverage cans per minute to about 3,000 cans per minute, i.e., mount a single can on a spindle or spindle assembly, print a pattern on the can, and remove the printed can from the spindle or spindle assembly.

It desirable that precise coordination exists between the beverage can printing system elements, the beverage cans, and other elements within the system, to prevent wear and associated economics of maintenance, repair, and replacement of parts (elements) of the printing system. Subsequently, there may be substantial loss of production when a spindle(s) or a spindle assembly(ies) does not function satisfactorily due to inadvertent production of defective cans and significant decrease in production during machine down time when unsatisfactory spindle(s) or spindle assembly(ies) must be replaced.

One particular element in a beverage can printing system or assembly, a spindle assembly, is subject to significant wear during the printing process. The wear of the spindle assembly can be significantly reduced by mounting a non-thermoplastic polyimide spindle cover on a spindle of the spindle assembly.

Accordingly, it the object of the present invention to provide a spindle cover made from material that is suitable for use in a spindle assembly, and subsequently for use in a spindle disc assembly, that will provide the desired wear performance and subsequently reduce down time in a beverage (or other) can printing or other processes. It is also the object of the present invention to provide low-wear cylindrical cover for use in mechanical applications and production processes to replace metal or other high-wear elements.

Beverage can printing systems or assemblies may often be referred to in the art as can decorators, can decorating machines, high speed continuous coating machines, and the like. In high speed continuous coating, decorating, and/or printing of metal can bodies such as, for example, aluminum or steel, the can bodies may each be supported on a plurality of circumferentially disposed and spaced spindles or spindle assemblies. The spindles or spindle assemblies are carried by continuous rotation of a spindle disc so as to engage the outer peripheral can surface with ink transfer blanket segments on a rotating blanket wheel of a decorator machine or with a coating applicator of a coating machine. A spindle, a spindle assembly, and a spindle disc may often be referred to in the art as a mandrel, a mandrel assembly, and a mandrel wheel, respectively.

The spindle disc, the spindles, and the spindle assemblies of such coater and decorator machines are generally of similar construction and design. Beverage can printing machines, systems and assemblies of this type known in the art, described in and shown in the following United States patents, which are incorporated herein by reference in their entirety: Sirvet U.S. Pat. No. 4,037,530; McMillin et al. U.S. Pat. No. 4,138,941; Dugan et al. U.S. Pat. No. 4,222,479; Stirbis U.S. Pat. No. 4,267,771; Han U.S. Pat. No. 4,441,418; Stribis U.S. Pat. No. 4,445,431; Stirbis U.S. Pat. No. 4,491,068; Stirbis U.S. Pat. No. 4,498,387; Stirbis U.S. Pat. No. 4,509,555; and Aichele U.S. Pat. No. 6,490,969. Such beverage can printing systems are continuously operated by a motor means and a drive means with various wheel means rotating synchronously. The construction and arrangement is such that each beverage can is decorated along a preselected range during each 360 degree revolution of the spindle disc means when in contact with a blanket segment. Beverage can printing systems of this type may be operable between relatively low speeds of about 500 cans per minute and relatively high speeds of 1,200 to 2,000 or more cans per minute.

In general, each of the spindles or spindle assemblies may comprise a means for supporting a central spindle shaft, which is attached to and carried in a circumferential path by the rotatable spindle disc. A spindle is mounted on each of the spindle shaft means by a suitable bearing means. Spindles and spindle assemblies of this type are described and shown in United States patents, which are herein incorporated by reference in their entirety: Stirbis U.S. Pat. No. 4,2677,771; Sirvet U.S. Pat. No. 4,037,530; Demierre U.S. Pat. No. 3,710,712; Cohan U.S. Pat. No. 3,388,686, and Zurick U.S. Pat. No. 3,356,019; and Metcalf U.S. Pat. No. 4,926,788.

Examples of beverage can printing systems include but are not limited to a Concord/Rutherford Decorator and Base Coater available from Stolle Machinery Company, LLC of Centennial Colo., USA; and a Ragsdale Decorator and Base Coater available from Alcoa. Other general examples of beverage can printing systems are described and shown in U.S. Pat. Nos. 3,766,851 and 5,111,742; and W.I.P.O. Pat. App. No. PCT/US98/11190, which are herein incorporated by reference in their entirety.

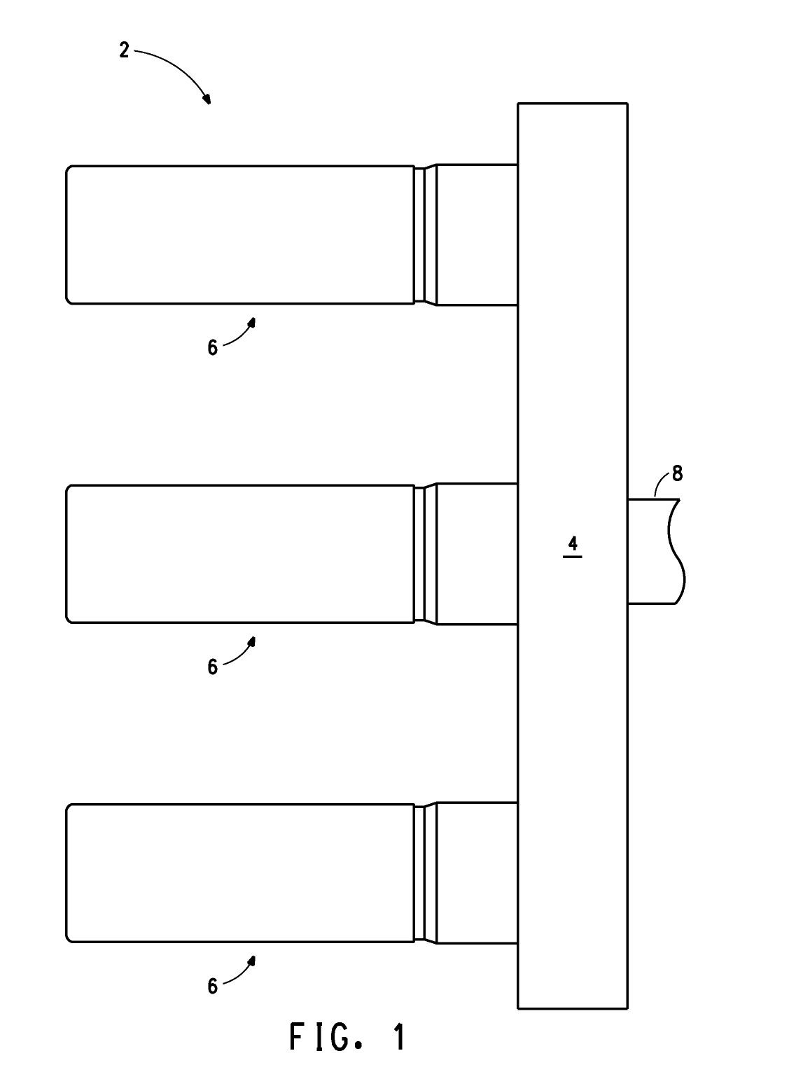

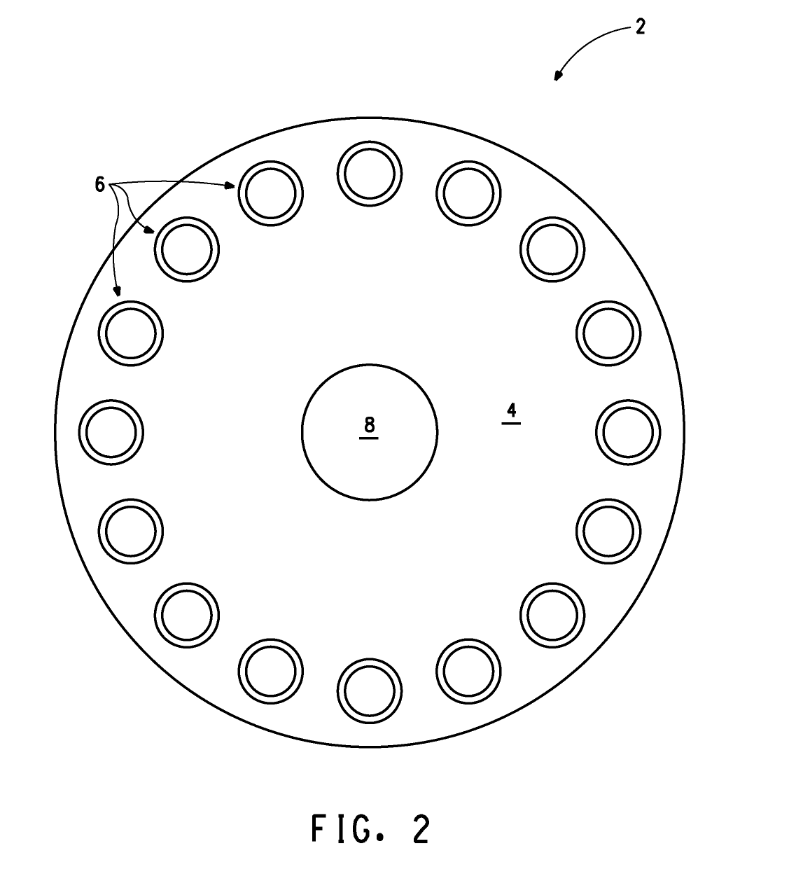

Referring to FIGS. 1 and 2, spindle disc assembly 2 may comprise a spindle disc 4 and spindle assemblies 6. Reference 8 connotes a typical point of attachment, for example, a shaft, between spindle disc 4 and a typical beverage can printing system. Spindle disc 4 may have a plurality of spindle assemblies 6 disposed along the periphery of spindle disc 4 and may be an element of a beverage can printing system described herein. Spindle discs and spindle disc assemblies are known in the art.

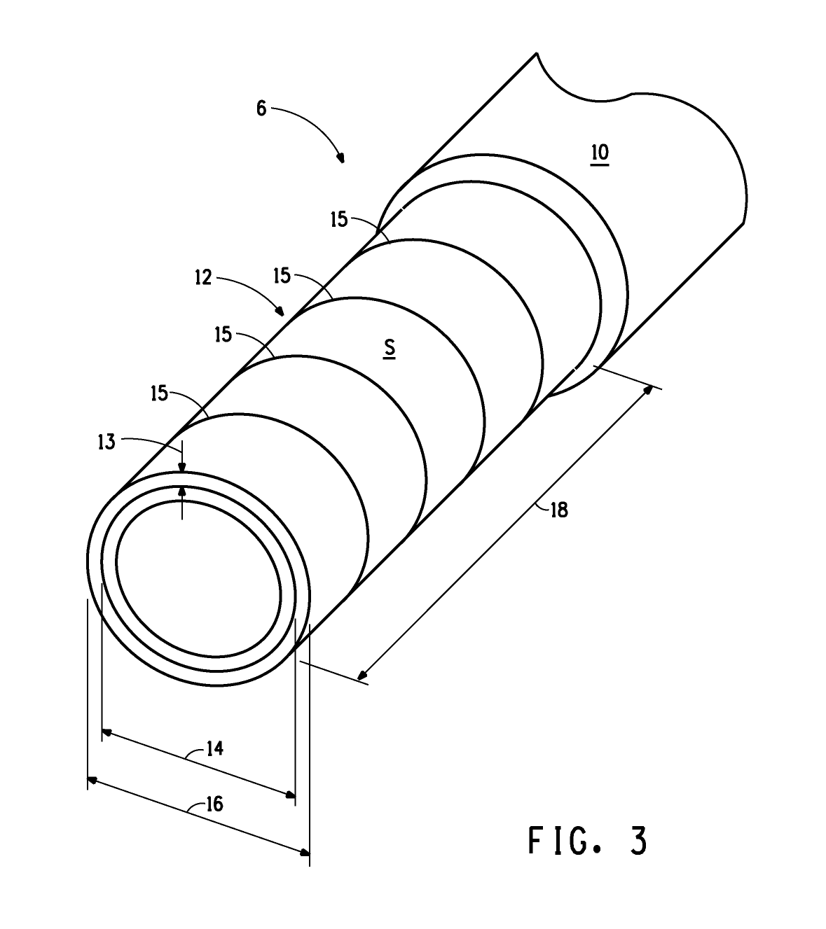

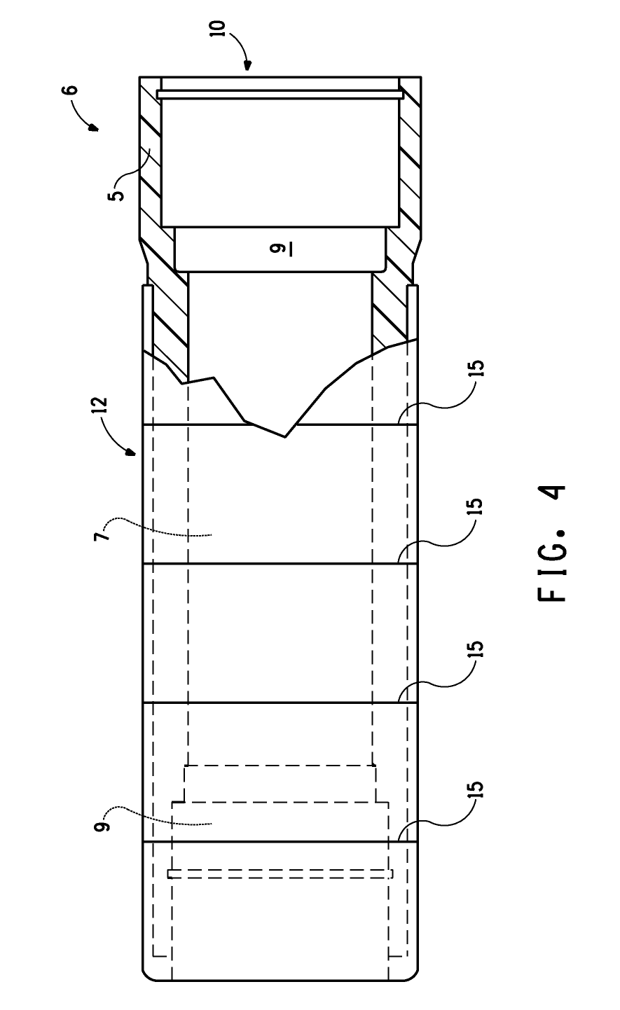

Referring to FIGS. 3 and 4, a spindle assembly 6 is shown. Spindle assembly 6 may comprise a spindle 10 and a spindle cover 12. Spindle 10 may typically comprise a polymeric material 5, such as for example, polyethylene terephthalate (PET). Polymeric material 5 typically overlays a hollow, metal body 7 having a ball or needle bearing unit 9 therein. Spindle 10 may typically be precision machined.

Spindle cover 12 may be a hollow cylinder, or hollow and generally cylindrical in shape.

Spindle cover 12 may have an inside diameter (ID) 14 in a range from about 15 mm to about 78 mm. In other embodiments, spindle cover 12 may have ID 14 in a range: from about 18 mm to about 70 mm; from about 17 mm to about 64 mm; from about 16 mm to about 25 mm; from about 19 mm to about 22 mm; from about 30 mm to about 69 mm; from about 35 mm to about 67 mm; from about 40 mm to about 65 mm; from about 45 mm to about 55 mm; from about 49 mm to about 53 mm; from about 55 mm to about 68 mm; or from about 60 mm to about 66 mm. In an embodiment, spindle cover 12 may have ID 14 of about 20 mm.

Spindle cover 12 may have an outside diameter (OD) 16 in a range from about 25 mm to about 80 mm. In other embodiments, spindle cover 12 may have OD 16 in a range: from about 28 mm to about 70 mm; from about 28 mm to about 66 mm; from about 26 mm to about 35 mm; from about 29 mm to about 31 mm; from about 40 mm to about 75 mm; from about 45 mm to about 71 mm; from about 49 mm to about 69 mm; from about 51 mm to about 67 mm; from about 60 mm to about 67 mm; or from about 48 mm to about 53 mm. In an embodiment, spindle cover 12 may have OD 16 of about 30 mm.

Spindle cover 12 has a wall thickness (T) 13 in a range from about 1 mm to about 10 mm. In other embodiments, the spindle cover 12 has T 13 in a range: from about 2 mm to about 8 mm; 4 mm to about 6 mm; 1 mm to about 7 mm; 2 mm to about 5 mm; 5 mm to about 10 mm; or 7 mm to about 10 mm. In an embodiment, the spindle cover 2 has a T 13 of about 5 mm. With such thickness, the spindle cover sufficiently functions as a protection for the spindle from frictional forces. The wall thickness (T) 13 may be defined or determined by taking half of the difference between OD 16 and ID 14 of spindle cover 2; T 3=(OD 16−ID 14)/2.

Spindle cover 12 may have a length (L) 18 in a range from about 10 mm to about 200 mm. In other embodiments, spindle cover 12 may have L 18 in a range: from about 20 mm to about 190 mm; 25 mm to about 180 mm; 80 mm to about 195 mm; 85 mm to about 185 mm; 90 mm to about 175 mm; 10 mm to about 100 mm; 25 mm to about 80 mm; 28 mm to about 50 mm; 30 mm to about 110 mm; 40 mm to about 90 mm; or 45 mm to about 80 mm. In an embodiment, spindle cover 12 may have L 18 of about 30 mm.

In other embodiments, spindle cover 12 have a L 18 of about: 11 mm, 13, mm, 15 mm, 17 mm, 19 mm, 21 mm, 23 mm, 25 mm, 27 mm, 29 mm, 31 mm, 33 mm, 35 mm, 37 mm, 39 mm, 41 mm, 43 mm, 45 mm, 47 mm, 49 mm, 51 mm, 53 mm, 55 mm, 57 mm, 59 mm, 61 mm, 63 mm, 65 mm, 67 mm, 69 mm, 71 mm, 73 mm, 75 mm, 77 mm, 79 mm, 81 mm, 83 mm, 85 mm, 87 mm, 89 mm, 91 mm, 93 mm, 95 mm, 97 mm, 99 mm, 101 mm, 103 mm, 105 mm, 107 mm, 109 mm, 111 mm, 113 mm, 115 mm, 117 mm, 119 mm, 121 mm, 123 mm, 125 mm, 127 mm, 129 mm, 130 mm, 131 mm, 132 mm, 133 mm, 135 mm, 137 mm, 139 mm, 141 mm, 143 mm, 145 mm, 147 mm, 149 mm, 151 mm, 153 mm, 155 mm, 157 mm, 159 mm, 161 mm, 163 mm, 165 mm, 167 mm, 169 mm, 171 mm, 173 mm, 175 mm, 177 mm, 179 mm, 181 mm, 183 mm, 185 mm, 187 mm, 189 mm, 191 mm, 193 mm, 195 mm, 197 mm, or 199 mm.

In other embodiments, spindle cover 12 have a L 18 of about: 10 mm, 12 mm, 14 mm, 16 mm, 18 mm, 20 mm, 22 mm, 24 mm, 26 mm, 28 mm, 30 mm, 32 mm, 34 mm, 36 mm, 38 mm, 40 mm, 42 mm, 44 mm, 46 mm, 48 mm, 50 mm, 52 mm, 54 mm, 56 mm, 58 mm, 60 mm, 62 mm, 64 mm, 66 mm, 68 mm, 70 mm, 72 mm, 74 mm, 76 mm, 78 mm, 80 mm, 82 mm, 84 mm, 86 mm, 88 mm, 90 mm, 92 mm, 94 mm, 96 mm, 98 mm, 100 mm, 102 mm, 104 mm, 106 mm, 108 mm, 110 mm, 112 mm, 114 mm, 116 mm, 118 mm, 120 mm, 122 mm, 124 mm, 126 mm, 128 mm, 130 mm, 132 mm, 134 mm, 136 mm, 138 mm, 140 mm, 142 mm, 144 mm, 146 mm, 148 mm, 150 mm, 152 mm, 154 mm, 156 mm, 158 mm, 160 mm, 162 mm, 164 mm, 166 mm, 168 mm, 170 mm, 172 mm, 174 mm, 176 mm, 178 mm, 180 mm, 182 mm, 184 mm, 186 mm, 188 mm, 190 mm, 192 mm, 194 mm, 196 mm, 198 mm, or 200 mm.

In an embodiment, spindle cover 12 may have ID 14 in a range from about 15 mm to about 78 mm, OD 16 in a range from 25 mm to about 80 mm, and L 18 in a range from about 10 mm to about 200 mm. In other embodiments, spindle cover 12 may have: ID 14 in a range from about 15 mm to about 20 mm, OD 16 in a range from about 25 mm to about 20 mm, L 18 from about 20 mm to about 30 mm; ID 14 in a range from about 15 mm to about 64 mm, OD 16 in a range from about 25 mm to about 67 mm, L 18 from about 20 mm to about 190 mm; or ID 14 in a range from about 45 mm to about 78 mm, OD 16 in a range from about 55 mm to about 80 mm, L 18 from about 88 mm to about 190 mm.

In another embodiment, spindle cover 12 may have ID 14 of about 20 mm, OD 16 of about 30 mm, and L 18 of about 30 mm.

The surface (S) of spindle cover 12 may be described as smooth and may have seams 15. Seams 15, while not necessarily visible to the naked eye, may exist as a result of the method of manufacturing spindle cover 12. Seams 15 may be characterized by the finished surface roughness. In an embodiment, S may have a finished surface roughness (Ra, arithmetical mean deviation of the roughness profile) of less than about 1.6 microns.

### Graphite Filled Non-Thermoplastic Polyimide Compositions

Spindle covers described herein may comprise a non-thermoplastic polyimide. In an embodiment, non-thermoplastic polyimide compositions that may be used in the spindle covers are described in U.S. Pat. Nos. 3,179,614; 3,179,631; and 4,360,626, which are incorporated herein by reference in their entirety.

In an embodiment, the non-thermoplastic polyimide compositions suitable for use with the spindle covers disclosed herein may contain graphite. The graphite is commercially available in a wide variety of forms as a fine powder and may typically be admixed with a polymer solution before precipitation of the polyimide from the solution. The particle size of the graphite may vary widely, but is generally be in a range from about 5 microns (μm) to about 75 μm. In an embodiment, the average particle size may be about 5 μm to about 25 μm. The total concentration of the graphite introduced into the polyimide resin may vary with the final wear properties desired for a spindle cover. In an embodiment, the spindle cover additionally comprises about 5% by volume to about 75 percent (%) by volume graphite based on the volume of the spindle cover.

The non-thermoplastic polyimide compositions may have markedly improved (favorable for use herein) physical properties by using graphite having less than about 0.15 weight percent (wt %) reactive impurities. In an embodiment, the non-thermoplastic polyimide composition may contain graphite having less than about 0.01 wt % deleterious reactive impurities. Examples of deleterious reactive impurities may include iron sulfide, and oxides and sulfides of barium, calcium, and copper.

The graphite can contain less than about 0.15 wt % of at least one reactive impurity selected from the group consisting of ferric sulfide, barium sulfide, calcium sulfide, copper sulfide, barium oxide, calcium oxide, copper oxide and a mixture thereof in an embodiment.

The graphite used may be either naturally occurring graphite or synthetic graphite. Natural graphite generally may have a wide range of impurity concentrations; while synthetically produced graphite may be commercially available having low reactive impurity concentrations. Graphite containing a high concentration of impurities may be purified by chemical treatment with a mineral acid. For example, treatment of the impure graphite with sulfuric, nitric, or hydrochloric acid at elevated or reflux temperatures may be used to reduce the impurities to an acceptable level. Alternatively, commercial graphite compositions may be available that typically satisfy the purity levels required for non-thermoplastic polyimide compositions that may be used in a spindle cover, such as “Dixon Airspun KS-5” commercially available from The Joseph Dixon Crucible Co., Heathrow, Fla., U.S.A

The non-thermoplastic polyimide compositions suitable for making the spindle covers disclosed herein may be prepared from pyromellitic dianhydride and 4,4′-oxydianiline in an embodiment according to the procedures known in the art and described in U.S. Pat. No. 3,179,614, which is incorporated herein by reference in its entirety. Graphite may be incorporated into a polymer solution prior to precipitation resulting in the non-thermoplastic polyimide resin comprising graphite in an embodiment. Non-thermoplastic polyimide resins containing graphite are commercially available from E.I. du Pont de Nemours and Company of Wilmington, Del., U.S.A. under the DuPont™ Vespel® brand, S grade of materials. Examples of DuPont™ Vespel® brand, S grade of materials include: SP-1, SP-3, SP-21, SP-22, SP-211, SP-214, SP-224, and SP-2515, all of which are suitable for the spindle covers disclosed and described herein.

### Oxidatively Stable, Rigid, Aromatic, Non-Thermoplastic Polyimide Compositions

In another embodiment, non-thermoplastic polyimides that are suitable for use in spindle covers described herein may comprise compositions containing oxidatively stable, rigid, aromatic polyimides. The preparation of the aforementioned aromatic polyimides compositions are known in the art and as described in U.S. Pat. Nos. 3,249,588 and 5,886,129, which are incorporated herein by reference in their entirety. When using a solution imidization process, an aromatic tetracarboxylic dianhydride component may be reacted with a mixture of a p-phenylene diamine (PPD) and m-phenylene diamine (MPD) as the diamine component to form a reaction solution, which may then be subsequently imidized in solution and precipitated, such that the resulting polyimide composition exhibits unexpectedly improved oxidative stability and excellent tensile strength properties.

The term rigid polyimide is meant to connote that there are no flexible linkages in the polyimide unit.

Aromatic tetracarboxylic dianhydride components that may be used in the preparation of oxidatively stable, rigid, aromatic polyimides include pyromellitic dianhydride (PMDA); 3,3′,4,4′-biphenyltetracarboxylic dianhydride (BPDA); and any other rigid aromatic dianhydride.

In an embodiment, BPDA may be used as the dianhydride component. The solution imidization process may be used to provide a rigid, aromatic polyimide composition having the recurring unit

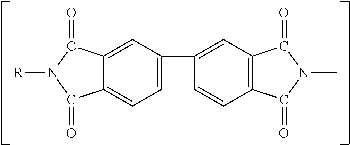

wherein R may be greater than about 60 mole % to about 85 mole % PPD units and about 15 mole % to less than about 40 mole % MPD units. In an embodiment, polyimide components may have about 70 mole % PPD and about 30 mole % MPD.

In preparation of the oxidatively stable, rigid, aromatic polyimide compositions, the solution imidization process may be utilized according to the following. The diamines (PPD and MPD) are generally first dissolved in a solvent to form the diamine component in the required concentration of the solvent; the dianhydride may be added to the reaction solution in substantially equimolar quantities to form a polyamide acid (PAA) polymer solution. A slight molar excess of either the dianhydride or diamine component may be possible. A molar excess of about 0.5% to about 1.0% of the diamine component may be used.

The resulting PAA polymer solution may be transferred over a period of time to a heated solution of the solvent. The transferred PAA polymer solution may be continuously heated and agitated to complete the reaction of soluble PAA to a slurry of insoluble polyimide.

The resulting polyimide slurry may be washed with solvent and dried at about 100° C. to about 230° C.; at about 140° C. to about 190° C.; or at about 180° C., to convert the polyimide slurry to a polyimide resin in the form of a powder having a high surface area. Depending on the particle size resulting from the precipitation of polyamide acid from the reaction solution, the particles of polyimide may be further modified for example, by suitable grinding techniques, to provide a desirable particle size for handling and subsequent molding.

The solvents that may be useful in the solution polymerization process for synthesizing the PAA polymer solution may be the organic solvents whose functional groups will not react with either of the reactants (the BPDA or the diamines) to any appreciable extent. The solvent may exhibit a pH of about 8 to about 10, which may be measured by mixing the solvent with a small amount of water and then measuring with pH paper or probe. Such solvents include, for example, pyridine and β-picoline. Of the solvents disclosed in U.S. Pat. Nos. 3,249,588 and 3,179,614, pyridine (KB=1.4×10−9) may be a useful solvent for these reactants in the polymerization reaction as well as functioning as the catalyst. For a dianhydride and a diamine to react to form a PAA polymer solution, a basic catalyst may be needed. Since pyridine is a basic compound, it may function herein as both a catalyst and a solvent.

The solvent may be present in a quantity such that the concentration of the PAA polymer solution may be about 1 wt % to about 15 wt %. In an embodiment, the quantity may be from about 8 wt % to about 12 wt %.

The surface area for a polyimide resin resulting from the polyimide composition may be at least about 20 m2/g. In an embodiment, the surface area may be at least about 75 m2/g to achieve acceptable physical properties and for ease of processability.

In the preparation of the PAA, it may be necessary that the molecular weight be such that the inherent viscosity (IV) of the PAA polymer solution may be at least about 0.2 dl/g. In an embodiment, the IV may be about 2.0 dl/g.

The oxidatively stable, rigid, aromatic, non-thermoplastic polyimide compositions suitable for making the spindle covers described herein may additionally comprise fillers, particularly carbonaceous fillers such as graphite, to improve wear and frictional characteristics while retaining the excellent tensile and oxidative stability of the polyimides. Other suitable are selected from the group consisting of molybdenum disulfide, kaolinite clay, and polytetrafluoroethylene polymers, copolymers, and combinations thereof. Fillers may be present in quantities ranging from about 0.1 wt % to about 80 wt %. The particular filler or fillers selected, as well as the quantities used, may depend on the effect desired in the final composition, as would be evident to those having ordinary skill in the art.

Theses fillers may be typically incorporated into the heated solvent prior to transfer of the PAA polymer solution so that the polyimide may be precipitated in the presence of the filler which then may therein be incorporated. The form of the fillers may depend on the function of the filler in the spindle cover. For example, the fillers may be in particulate or fibrous form.

The oxidatively stable, rigid, aromatic polyimide compositions for use in the spindle cover may be molded under elevated pressures to a wide variety of configurations. In an embodiment, the polyimide compositions may be molded at pressures of about 50,000 psi to about 100,000 psi (about 345 Mpa to about 690 Mpa) at ambient temperatures.

Non-thermoplastic polyimide resins comprising oxidatively stable, rigid, aromatic polyimides are commercially available from E.I. du Pont de Nemours and Company of Wilmington, Del., U.S.A. under the DuPont™ Vespel® brand, S grade of materials. Examples of DuPont™ Vespel® brand, S grade of materials include SCP-5000, SCP-5009, SCP-50094, and SCP-5050, all of which are suitable for the spindle covers described herein.

### Sheet Silicate, Non-Thermoplastic Polyimide Compositions

In another embodiment, non-thermoplastic polyimides that may be used in spindle covers described herein may be polyimide compositions containing an inorganic, low hardness, thermally stable, sheet silicate. Polyimide compositions containing sheet silicate, even at low concentrations, may greatly reduce wear and friction against a metal mating surface, such as steel, compared with the same composition which contains no sheet silicate additive. Examples and preparation of the aforementioned polyimide compositions are known in the art and are described in U.S. Pat. No. 5,789,523, which is incorporated herein by reference in its entirety.

The aforementioned polyimide compositions may contain (a) from about 70 wt % to about 99.9 wt % of at least one polyimide, but generally about 90 wt % to about 99 wt %; and (b) from about 0.1 wt % to about 30 wt % of at least one of an inorganic, low hardness, thermally stable, sheet silicate, the weight percentages being based upon the weight of components (a) and (b). The polyimides may comprise a polyimide composition which may be a blend of about 20 wt % to about 30 wt % of at least one polyimide; from about 45 wt % to about 79.9 wt % of at least one polymer which is melt processible at a temperature of less than about 400° C. and may be selected from polyamide resins and/or polyester resins; and from about 0.1 wt % to about 30 wt % of at least one of an inorganic, low hardness, thermally stable, sheet silicate.

A wide variety of polyimides may be suitable for use, including those known in the art and described in U.S. Pat. No. 3,179,614, which is incorporated herein by reference in its entirety. The polyimides described therein may be prepared from at least one diamine and at least one anhydride.

The diamine can be selected from the group consisting of m-phenylene diamine (MPD), p-phenylene diamine (PPD), oxydianiline (ODA), methylene dianiline (MDA), and toluene diamine (TDA) and a mixture there of in an embodiment. The diamine can be 4,4′-oxydianiline (ODA) in another embodiment.

The anhydride can be selected from the group consisting of benzophenone tetracarboxylic dianhydride (BTDA), biphenyl dianhydride (BPDA), trimellitic anhydride (TMA), pyromellitic dianhydride (PMDA), maleic anhydride (MA) nadic anhydride (NA) and a mixture thereof in an embodiment. The anhydride can be pyromellitic dianhydride (PMDA) in another embodiment.

Polyimides that may be used include those prepared from the following combinations of anhydride and diamine: BTDA-MPD; MA-MDA, BTDA-TDA-MPD; BTDA-MDA-NA; TMA-MPD & TMA-ODA; BPDA-ODA; BPDA-MPD; BPDA-PPD, BTDA-4,4′-diaminobenzophenone; and BTDA-bis(p-phenoxy)-p,p′-biphenyl. A useful polyimide may be prepared from pyromellitic dianhydride and 4,4′-oxydianiline (PMDA-ODA).

The polyimide compositions may contain from about 0.1 wt % to about 30 wt % of an inorganic, low hardness, thermally stable, sheet silicate, such as muscovite mica [KAl₃Si₃O₁₀], talc [Mg₃Si₄O₁₀(OH)₂], and kaolinite [Al₂Si₂O₅(OH)₄], and mixtures thereof. Sheet silicates of this kind may have strong two-dimensional bonding within the silicate layers, but weak inter-layer bonding, which may give rise to lubricating characteristics of a platey compound such as graphite. The term inorganic may include sheet silicates which occur naturally as well as those which may be synthesized in a lab. Low hardness may be desirable to preclude abrasiveness toward the mating surface. Hardness is a mineral's ability to resist scratching of its smooth surface. Mohs Scale of Hardness is known to those skilled in the art to be the scale wherein talc has a hardness of 1 (least hard) and a diamond has a hardness of 10 (most hard).

In preparation of the sheet silicate polyimide compositions; the order of addition of the components may not be critical. The two basic components, the polyimide and the inorganic, sheet silicate may be blended in the required quantities using conventional milling techniques. The sheet silicate may also be conveniently incorporated into the polyimide as an alternative to milling by blending into a polymer solution of polyimide precursors prior to precipitation as the polyimide.

For the polyimide compositions described herein, low hardness is understood to be less than 5 on the Mohs Scale of Hardness. In addition, maintaining phase stability of crystal structure of the sheet silicates may be critical, as is maintaining thermal stability of the sheet silicates' structural water at temperatures of up to 450° C., as shown by thermogravimetric analysis (TGA). Thermal loss of the structural water during processing of the polyimide composition may result in harm to polyimide integrity and possibly change the crystal structure of the sheet silicate, giving a harder, more abrasive compound. Examples of sheet silicates which may not be stable enough to be included in the present polyimide compositions are montmorillonite [(½Ca.Na)0.35(Al.Mg)₂(Si.Al)₄O₁₀(OH)₂.nH₂O], vermiculite [(Mg.CA)0.35(Mg.Fe.Al)₃(Al.SO₄)O₁₀(OH)₂4H₂O], and pyrophyllite [Al₂Si₄O₁₀(OH)₂]. Also, inorganic compounds which have a 3-D structure rather than a sheet structure, such as silica (SiO)₂, barite (BaSO₄), and calcite (CaCO₃), may not have the beneficial effects of the compounds included in the polyimide compositions.

Dramatic improvements in the wear and friction characteristics of the polyimide compositions may be exhibited with about 1 wt % of one of the sheet silicates. In an embodiment, the polyimide compositions may comprise about 0.1 wt % to about 20 wt % of sheet silicate. In another embodiment, the polyimide compositions may comprise about 1 wt % to about 10 wt % of sheet silicate.

Blends of polyimide with polyamide and polyester resins may exhibit greatly reduced wear and friction characteristics when a sheet silicate is incorporated. The sheet silicate polyimide compositions described herein may be a blend of at least one polyimide, in range from about 20 wt % to about 30 wt %, with at least one other polymer which may be melt processible at a temperature of less than about 400° C., and may be selected from polyamide and polyester resins and may be present in a concentration from about 45 wt % to about 79.9 wt %. Melt processible is used in its conventional sense, that the polymer may be processed in an extrusion apparatus at the indicated temperatures without substantial degradation of the polymer. Such polymers may include polyamides or polyesters.

A wide variety of polyamides and/or polyesters may be blended with polyimides. For example, polyamides which may be used include nylon 6; nylon 6,6; nylon 6,10; and nylon 6,12. Polyesters which may be used include polybutylene terephthalate and polyethylene terephthalate. A fusible or melt processible polyamide or polyester may be in the form of a liquid crystal polymer (LCD). LCPs are generally polyesters, including, but not limited to, polyesteramides and polyesterimides. Suitable LCPs are described in U.S. Pat. Nos. 4,169,933; 4,242,496; and 4,238,600, as well as in “Liquid Crystal Polymers: VI Liquid Crystalline Polyesters of Substituted Hydroquinones.”

In preparation of the polyimide compositions additionally comprising polyamide or polyester resin, the order of addition of the components still may not be critical. The three basic components, the polyimide, the inorganic, sheet silicate, the polyamide or the polyester resin may be blended in the required quantities using conventional milling techniques. The sheet silicate may also be conveniently incorporated into the polyimide as an alternative to milling by blending into a polymer solution of polyimide precursors prior to precipitation as the polyimide.

The sheet silicate polyimide compositions described herein may further include other additives, fillers, and dry lubricants which would not depreciate the overall characteristics of the finished spindle covers described herein. The additives may be present in an amount from 0 wt % to about 29.9 wt % based upon the total weight of the polyimide, silicate sheet, and additive components. In an embodiment, the incorporation of graphite into the polyimide composition may extend the range of its utility as a wear resistant material. In another embodiment, the polyimide composition may contain a carbon fiber additive in a range from 0 wt % to about 5 wt % based upon the total weight of the polyimide, silicate sheet, and additive components.

Non-thermoplastic polyimide resins comprising an inorganic, low hardness, thermally stable, sheet silicate are commercially available from E.I. du Pont de Nemours and Company of Wilmington, Del., U.S.A. under the DuPont™ Vespel® brand, S grade of materials. Examples of DuPont™ Vespel® brand, S grade of materials include SCP-50094, which is suitable for the spindle covers described herein.

Spindle cover 12 comprising non-thermoplastic polyimides disclosed herein may be used with spindle 10 to reduce and/or eliminate the wear associated with spindle 10 and/or spindle assembly 6 during operation of a beverage can printing system, and thus: reduce and/or eliminate replacement of spindle(s) 10 and/or spindle assembly(ies) 6; reduce and/or eliminate production of defective cans; and significantly reduce machine down time as spindle cover 12 may be removable, and be replaced with another if an undesirable amount of wear occurs on spindle cover 12. In another embodiment, spindle cover 12 may be removable from the spindle, the spindle assembly, from spindle disc assembly 2, or from a can printing assembly. For example, if spindle cover 12 is secured to spindle 10 by screws, the screws may simply be removed to separate spindle cover 12 from spindle 10. Additionally, spindle cover 12 comprising non-thermoplastic polyimides disclosed herein may be used with spindle 10 or as an element of spindle assembly 6 to reduce and/or eliminate unwanted damage to the soft beverage cans used in the beverage can printing process.

An embodiment of spindle assembly 6 comprising spindle 10 and spindle cover 12, wherein spindle cover 12 comprises a non-thermoplastic polyimide containing graphite; oxidatively stable, rigid, aromatic polyimides; non-thermoplastic polyimide containing an inorganic, low hardness, thermally stable, sheet silicate; or any of the polyimide compositions described herein may be formed by an embodiment of the method described herein.

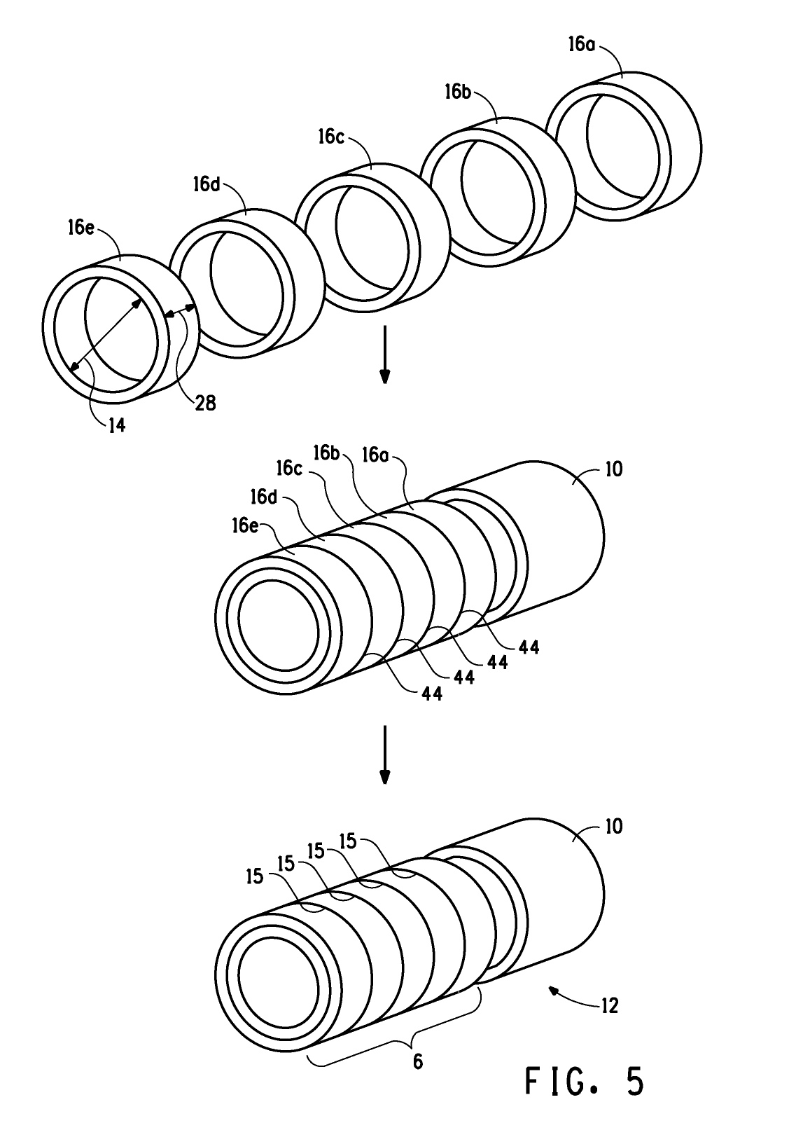

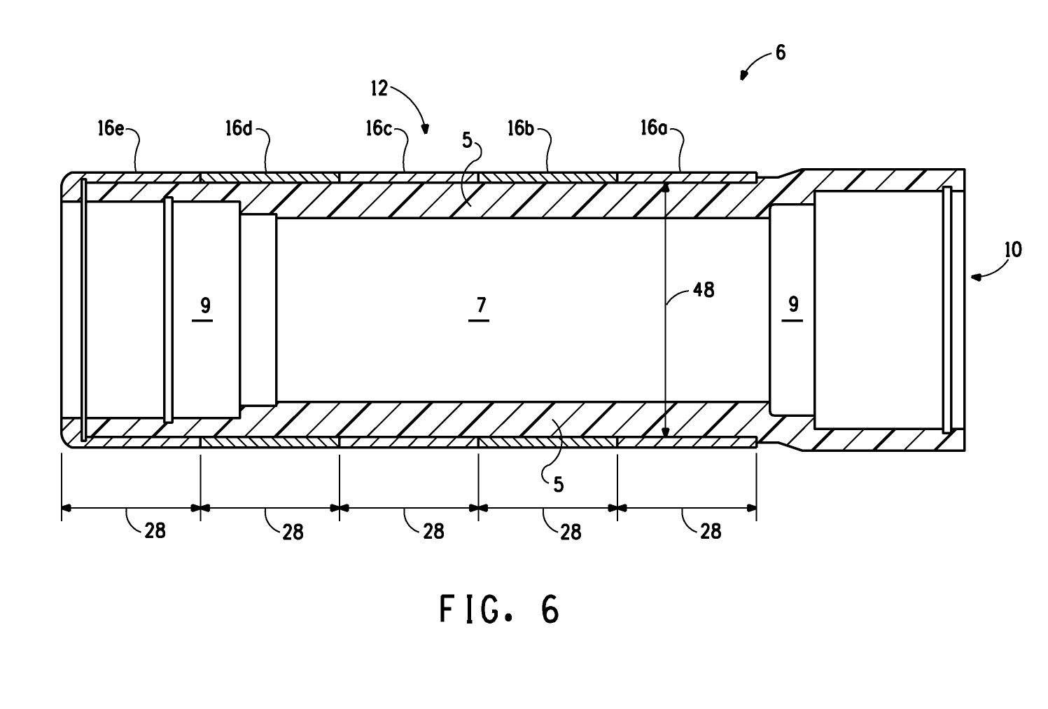

FIG. 5 shows an embodiment of spindle assembly 6 in accordance with the present invention. FIG. 6 shows an embodiment of a cross-section of spindle assembly 6. Referring to FIGS. 3, 5, and 6, resins of the non-thermoplastic polyimide compositions described herein may be processed to form rings 16a, 16b, 16c, 16d, and 16e by direct forming the compositions at a pressure of about 100,000 psi. The resultant molded rings 16a-e may be sintered for three hours at a temperature of about 400° C. under nitrogen at atmospheric pressure. Rings 16a-e may be direct formed to have a preselected inner diameter (ID) 14 and a preselected length (L) 28, which in turn are used to form spindle cover 12. The ID 14 of rings 16a-e correspond to ID 14 of spindle cover 12 and the sum of the lengths 28, see FIG. 5, of the individual rings 16a-e correspond to L 18, see FIG. 3, of spindle cover 12. The aforementioned rings can be purchased from E.I. du Pont de Nemours and Company of Wilmington and Company, DE, U.S.A.

After direct forming of rings 16a-e, the rings may be heated to expand ID 14 of rings 16a-e and then, a spindle 10 may be inserted through heated rings 16a-e. Spindle 10 may typically comprise a polymeric material 5, such as for example, polyethylene terephthalate (PET). Polymeric material 5 typically overlays a hollow, metal body 7 having a ball or needle bearing unit 9 therein. Prior to insertion of spindle 10 through heated rings 16a-e, the area of polymeric material 5 that may support heated rings 16a-e and subsequently formed spindle cover 12 may be machined to remove a preselected amount of polymeric material 5 such that an OD 48 of the machined area of spindle 10 is about, or is substantially the same as ID 14 of spindle cover 12.

Rings 16a-e may then be oriented such that rings 16a-e may be flush with each other and have seams 44 (the points of contact between rings 16a-e). After cooling to room temperature, rings 16a-e may then be secured to spindle 10 by press fitting or the use of screws. In an embodiment, all of rings 16a-e may be press fitted to spindle 10. In another embodiment, all of rings 16a-e may be secured to spindle 10 by using screws. In another embodiment, any of rings 16a-e may be secured to spindle 10 by a combination of press fitting and the use of screws, or other suitable fastening means.

Rings 16a-e may now be machined, for example, using a lathe, using a lathe, on or about seams 44, to achieve an OD, of the spindle cover 12; to a preselected OD; and to smooth the surface of rings 16a-e resulting in the formation of spindle cover 12 having a smooth and/or uniform surface, a monolithic appearance; and seams 15 which may have a depth and width significantly less than seams 44 prior to machining and surface S may have a surface roughness significantly smoother prior to machining. In an embodiment, S may have a finished Ra less than about 1.6 microns.

The ID 14 of rings 16a-e used to form spindle cover 12 may be preselected to be any diameter so as to match ID 14 of spindle cover 12 without any undue experimentation. Likewise, the individual L 28 of rings 16 used to form spindle cover 12 may be preselected to be any length so as the sum of L 28 of rings 16 match L 18 of the final spindle cover 12 article without any undue experimentation, and the OD of rings 16a-e may be machined to match a preselected OD 16 of spindle cover 12 which may correspond to the inner diameter or less of a can subject to printing.

An example of an embodiment of forming a spindle cover 12 in accordance with the present invention is described herein. Referring to FIGS. 3, 5, and 6, resins of the non-thermoplastic polyimide compositions described herein may be processed to form rings 16a, 16b, 16c, 16d, and 16e by direct forming the compositions at a pressure of about 100,000 psi. The resultant molded rings 16a-e may be sintered for three hours at a temperature of about 400° C. under nitrogen at atmospheric pressure. Rings 16a-e may be direct formed to have ID 14 of about 50 mm and L 28 of about 40 mm.

After direct forming of rings 16a-e, the rings may be heated to expand ID 14 of rings 16a-e and then, a spindle 10 having ID of about 50 mm may be inserted through heated rings 16a-e. Spindle 10 may comprise a polymeric material 5, such as for example, polyethylene terephthalate (PET). Polymeric material 5 typically overlays a hollow, metal body 7 having a ball or needle bearing unit 9 therein. Prior to insertion of spindle 10 through heated rings 16a-e, the area of polymeric material 5 that may support heated rings 16a-e and subsequently formed spindle cover 12 may be machined to remove a preselected amount of polymeric material 5 such that OD 48 of the machined area of spindle 12 may be about 50 mm.

Rings 16a-e may then be oriented such that rings 16a-e may be flush with each other and have seams 44 (the points of contact between rings 16a-e). After cooling to room temperature, rings 16a-d may then be secured to spindle 10 by press fitting and ring 16e may be secured using screws (not shown).

Rings 16a-e may now be machined, for example, using a lathe, on or about seams 44, to achieve an OD, of spindle cover 12, of about 67 mm, and to smooth the surface of rings 16a-e resulting in the formation of spindle cover 12 having a smooth and/or uniform surface, a monolithic appearance; a L 18 of about 200 mm (the sum of the lengths of rings 16a-e); and seams 15 which may have a depth and width significantly less than seams 44 prior to machining and surface S may have a surface roughness significantly smoother prior to machining. In an embodiment, S may have a finished Ra less than about 1.6 microns.

The terms “first”, “second”, and the like, herein do not denote any order, quantity, or importance, but rather are used to distinguish one element from another, and the terms “a” and “an” herein do not denote a limitation of quantity, but rather denotes the presence of at least one of the referenced items. The modifier “about” used in connection with a quantity is inclusive of the state value and has the meaning dictated by the context, (e.g., includes the degree of error associated with measurement of the particular quantity). The suffix “(s)” as used herein is intended to include both the singular and the plural of the term that it modifies, thereby including one or more of that term (e.g., the metal(s) includes one or more metals). Ranges disclosed herein are inclusive and independently combinable (e.g., ranges of “to about 25 wt %, or, more specifically, about 5 wt % to about 20 wt %”, is inclusive of the endpoints and all intermediate values of ranges of “about 5 wt % to about 25 wt %”, etc.)

While various embodiments are described herein, it will be appreciated from the specification that various embodiments of elements, variations or improvements therein may be made by those skilled in the art, and are within the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

### EXAMPLES

The present invention is illustrated by, but is not limited to, the following examples.

### Example 1

A hollow cylinder of non-thermoplastic polyimide (Vespel® SP-21, E.I. du Pont de Nemours and Company of Wilmington, Del., U.S.A) was direct formed and then post-processed by machining to make a spindle cover. The spindle cover has an inside diameter (ID) of 20 mm, an outside diameter (OD) of 30 mm, a thickness (T) of 5 mm, and a length (L) of 30 mm. The spindle cover of example 1 is a single piece.

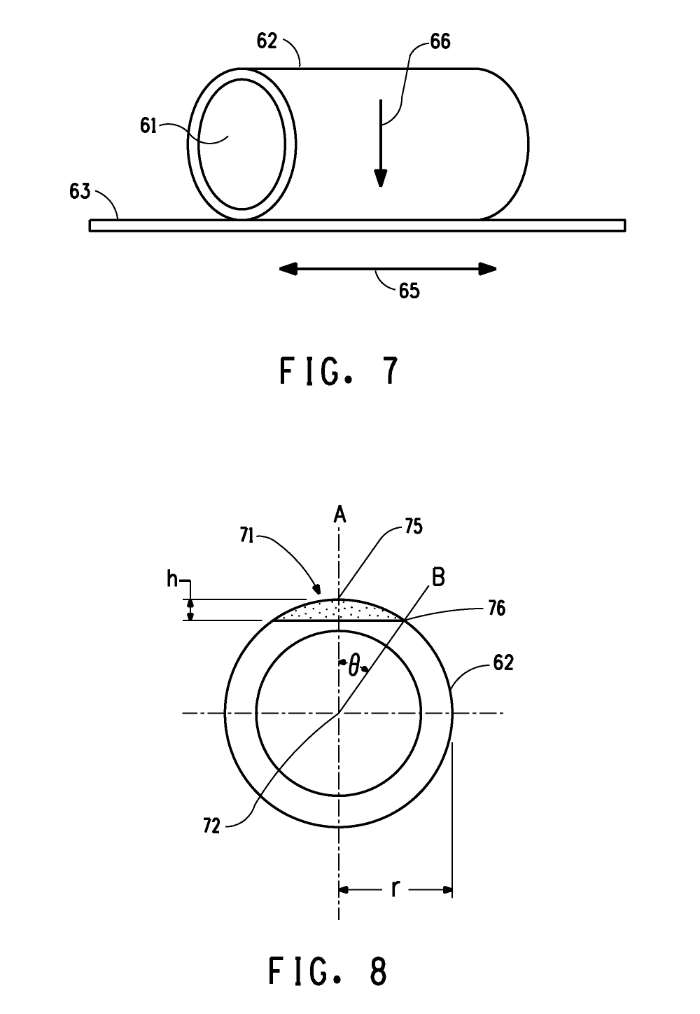

Referring to FIG. 7, a spindle 61 made of PET with diameter of 20 mm was provided. The spindle cover 62 was secured to spindle 61 by press fitting.

Spindle 61 with spindle cover 62 thereon was set on an aluminum plate 63 in a reciprocating sliding machine. Aluminum plate 63 slides back and forth in the horizontal direction 65 under a load of 0.65 N in a vertical direction 66 to impart wear on spindle cover 62 as a result of friction between aluminum plate 63 and spindle cover 62. The stroke distance of the sliding was 30 mm. The less the wear volume due to friction, the longer spindle cover 62 can be used.

Referring to FIG. 8, a wear volume 71 of spindle cover 62 after sliding strokes of 3,000 times, 24,000 times and 120,000 times was respectively measured. The wear volume 71 was calculated with the following equation where radius (r) of the outer side of spindle cover 62 was 15 mm, a worn height (h) and an angle (θ) between a line A connecting a center 72 of spindle cover 62 and a middle point 75 of the worn outer perimeter and a line B connecting center 72 and one end 76 of the worn outer perimeter. Angle (θ) was calculated as [cos⁻¹((r−h)/r)].

Wear volume(mm³)=wear area(mm²)×30 mm(spindle cover length)

Wear area(mm²)=πr²/2−r×(r−h)×sinθ−2×πr²×(90°−θ)/360°

### Example 2

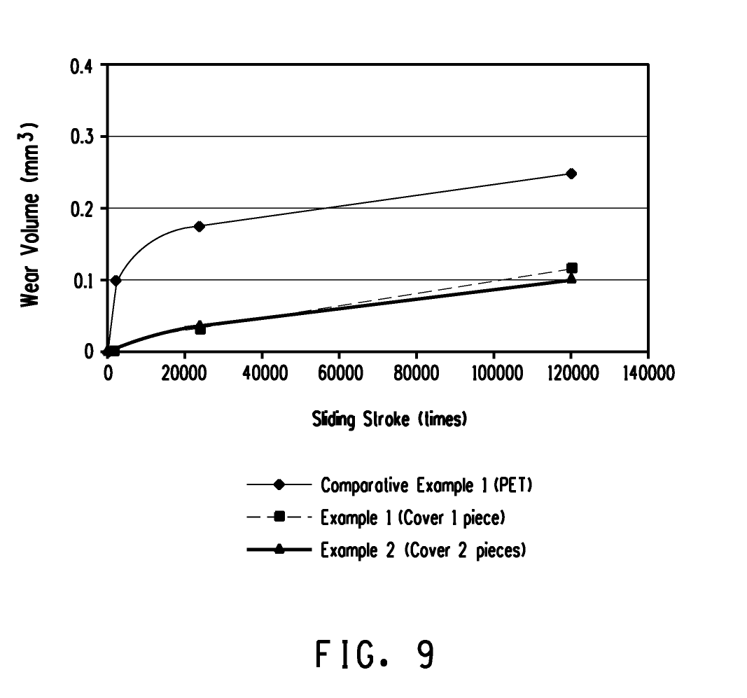

A spindle cover was made comprising two non-thermoplastic polyimide (Vespel® SP-21, E.I. du Pont de Nemours and Company of Wilmington, Del., U.S.A) rings with the length of 15 mm each. The rings were used to form a spindle cover by the method described herein. The wear volume in the reciprocating sliding test was measured as well as Example 1 and the results are shown in FIG. 9 and Table 1. The wear volume was 0.1 mm³ after 120,000 times of sliding strokes, which was also sufficiently small.

### Comparative Example 1

A spindle cover made of PET having the diameter of 30 mm was set in the reciprocating sliding test to measure the wear volume in the same manner as Example 1. The wear volume was measured and shown in FIG. 8 as well as Example 1. The wear volume was already 0.1 mm³ after 3,000 times of sliding strokes, 0.17 mm³ after 24,000 times of sliding strokes, 0.25 mm³ after 120,000 times of sliding strokes which was over double of the wear volume in Example 1 and 2 as shown in FIG. 9 and Table 1.

The wear volume was 0.12 mm³ after 120,000 times of sliding strokes as shown in FIG. 8 and Table 1, which was sufficiently small. The spindle cover comprising non-thermoplastic polyimide would be used longer period of time in the event of being adopted to a can printing system.

TABLE 1

| | Wear volume (mm³) | | |
|---|---|---|---|
| Frequency of | | | Comparative |
| Sliding strokes | Example 1 | Example 2 | Example 1 |
| 3000 | 0 | 0 | 0.1 |
| 24000 | 0.030 | 0.035 | 0.170 |
| 120000 | 0.120 | 0.100 | 0.250 |

What is claimed is:

1. A spindle disc assembly comprising: a spindle disc having a plurality of spindle assemblies disposed along the periphery of the spindle disc, the spindle assemblies each comprising a spindle cover, wherein the spindle cover has a wall thickness in a range from about 1 mm to about 10 mm, and wherein the spindle cover comprises a non-thermoplastic polyimide.

2. The spindle disc assembly according to claim 1, wherein the spindle cover has an inside diameter in a range from about 15 mm to about 78 mm, an outside diameter in a range from about 25 mm to about 80 mm, and a length in a range from about 10 mm to about 200 mm.

3. The spindle disc assembly according to claim 1, wherein the spindle cover comprises the non-thermoplastic polyimide prepared from at least one diamine and at least one anhydride.

4. The spindle disc assembly according to claim 3, wherein the diamine is selected from the group consisting of m-phenylene diamine (MPD), p-phenylene diamine (PPD), oxydianiline (ODA), methylene dianiline (MDA) toluene diamine (TDA) and a mixture thereof.

5. The spindle disc assembly according to claim 3, wherein the diamine is 4,4′-oxydianiline (ODA).

6. The spindle disc assembly according to claim 3, wherein the anhydride is selected from the group consisting of benzophenone tetracarboxylic dianhydride (BTDA), biphenyl dianhydride (BPDA), trimellitic anhydride (TMA), pyromellitic dianhydride (PMDA), maleic anhydride (MA) nadic anhydride (NA) and a mixture thereof.

7. The spindle disc assembly according to claim 3, wherein the anhydride is pyromellitic dianhydride (PMDA).

8. The spindle disc assembly according to claim 1, wherein the spindle cover additionally comprises about 5% by volume to about 75 percent (%) by volume graphite based on the volume of the spindle cover.

9. The spindle disc assembly according to claim 8, wherein the graphite contains less than about 0.15 weight percent (wt %) of at least one reactive impurity selected from the group consisting of ferric sulfide, barium sulfide, calcium sulfide, copper sulfide, barium oxide, calcium oxide, copper oxide and a mixture thereof.

10. The spindle disc assembly according to claim 1, wherein the spindle cover has an inside diameter in a range of about 20 mm, an outside diameter of about 30 mm, and a length of about 30 mm.
